(19) United States
(12) Patent Application Publication
(10) Pub. No.: US 2026/0110812 A1
(43) Pub. Date: Apr. 23, 2026

(54) FIRST ARRIVAL WAVE REVERSE TIME MIGRATION METHOD AND SYSTEM BASED ON EXCITATION AMPLITUDE

(71) Applicant: Institute of Geology and Geophysics, Chinese Academy of Sciences, Beijing (CN)

(72) Inventor: Zhiyuan Li, Beijing (CN)

(21) Appl. No.: 19/325,601

(22) Filed: Sep. 11, 2025

(30) Foreign Application Priority Data
Oct. 23, 2024 (CN) 202411481077.5

(51) Int. Cl. G01V 1/30

(52) U.S. Cl. CPC G01V 1/305; G01V 1/306; G01V 1/307

(57) ABSTRACT

A first arrival wave reverse time migration (RTM) method based on excitation amplitude includes the steps of acquiring calculation parameters of a seismic wave field, performing forward continuation on a source wave field, identifying a first arrival wave of the source wave field, and preserving the maximum amplitude and corresponding time of the first arrival wave; performing reverse time continuation on a receiver wave field; and cross-correlating the maximum amplitude of the source wave field with the receiver wave field at the same moment on each spatial grid node, and superimposing cross-correlation values to obtain an RTM result. In the present disclosure, by preserving the maximum amplitude and time of the first arrival wave, and cross-correlation imaging is conducted with the receiver wave field. The present disclosure can reduce the calculation amount and the interference of multi-path waves and improve a signal-to-noise ratio while ensuring the RTM imaging capability.

### CROSS-REFERENCE TO RELATED APPLICATION

This application claims priority of Chinese Patent Application No. 202411481077.5, filed on Oct. 23, 2024, the entire contents of which are incorporated herein by reference

### TECHNICAL FIELD

The present disclosure relates to the technical field of seismic source wave reverse time migration (RTM), and in particular to a first arrival wave RTM method and system based on excitation amplitude.

### BACKGROUND

In the field of geophysics, RTM is a migration method with the highest accuracy and strongest imaging ability at present. The implementation process is divided into three steps. (1) Forward continuation of source wave field. (2) Reverse time continuation of receiver wave field. (3) Utilization of imaging conditions (including cross-correlation imaging between source wave field and receiver wave field). This process needs to store the source wave field values at each moment in the computer, it needs a lot of computer memory, and the calculation cost is high. Compared with the cross-correlation imaging condition, the excitation amplitude imaging condition only needs to preserve the maximum amplitude value of each computational grid node and the corresponding time in the forward continuation process of the source wave field. Therefore, the computer memory is greatly saved, and the computational efficiency is improved. However, the excitation amplitude imaging condition cannot image multi-path waves because only one maximum amplitude and time are preserved at each grid node, thereby limiting the imaging capability. This is considered to be a drawback of the excitation amplitude imaging condition. One solution strategy is to preserve several maximum amplitude values and corresponding times thereof, and preserve a certain amount of multi-path waves for imaging. However, the imaging of multi-path waves is a complex problem. It is not simply to preserve multi-path waves and use cross-correlation imaging. Targeted processing methods are needed to achieve the objective of accurate imaging, otherwise most of the imaging noise will be generated. In fact, the excitation amplitude imaging condition is not without multi-path wave. In complex media, sometimes the amplitude value of the multi-path waves is stronger than that of the first arrival wave. Thus, when using the excitation amplitude imaging condition, the amplitude of the multi-path and the arrival time thereof are preserved and imaged.

In RTM, whether it is cross-correlation imaging condition or excitation amplitude imaging condition, the first arrival wave is mainly used to image the underground medium. For complex models, the excitation amplitude of the source wave field preserved by the existing excitation amplitude RTM method includes the amplitudes of first arrival wave field and multi-path wave field. For multi-path wave field, direct cross-correlation with the receiver wave field not only fails to image the underground media, but also generates offset noise, affecting the imaging quality. Therefore, there is a need for a first arrival RTM method and system based on excitation amplitude.

### SUMMARY

An objective of the present disclosure is to provide a first arrival RTM method and system based on excitation amplitude.

The method specifically includes the steps of:
acquiring calculation parameters of a source wave field, performing forward continuation on the source wave field, identifying a first arrival wave of the source wave field, and preserving the maximum amplitude and corresponding time of the first arrival wave at each spatial grid node;
performing reverse time continuation on a receiver wave field; and
cross-correlating the maximum amplitude of the source wave field with the receiver wave field at the same moment on each spatial grid node according to an excitation time, and superimposing cross-correlation values at all moments to obtain an RTM result.

Further, the acquiring calculation parameters of a seismic wave field includes grid size, number of grid nodes, seismic wave propagation velocity and density parameters at each grid node, spatial accuracy of numerical calculation of seismic wave field, time accuracy, and time step parameters; forward continuation is performed on the source wave field using an acoustic wave equation or an elastic wave equation, and the source wave field is calculated using numerical calculation methods including finite-difference method (FDM), finite-element method (FEM), and pseudo-spectral method (PSM); and the source wave field is denoted as U^{s}(x, t, s), where x represents a spatial location, t represents a time, and s represents a shot number.

Further, the identifying a first arrival wave of forward continuation of the source wave field includes the following calculation formulas:

$$EW {1}_{i} = {\sum }_{j = 1}^{i - n l} {w}_{j}^{2} \qquad ( 4 )$$

$${MCM}_{i} = \frac{E W {2}_{i} - EW {1}_{i}}{EW {2}_{i} + β} \qquad ( 5 )$$

setting Fᵢ as a first arrival wave identification factor, with an expression of:

$${F}_{i} = \{ \begin{matrix}1 & {MCM}_{i} >= th \\ 0 & {MCM}_{i} < th\end{matrix} \qquad ( 6 )$$

where i and j are the number of time steps; nl is a selected time window, corresponding to 2-3 dominant periods of a seismic wavelet; w is a seismic wave field value, and EW1ᵢ is a sum of all energy values of the seismic wave field from a 1^{st} to i−nl^{th} time steps; EW2ᵢ is a sum of all energy values of the seismic wave field from the 1^{st} to i^{th} time steps; MCMᵢ is a ratio of EW1ᵢ to EW2ᵢ; and β is a stabilization factor with a value of 0.2, th is a given threshold, and when a value F corresponding to a wave field value at a certain moment step equals 1, it indicates that the wave field is the first arrival wave.

Further, the identifying a first arrival wave adopts a short-time average/long-time average ratio method (STA/LTA method), a modified energy ratio method (modified method), a modified Coppen method, or an Akaike information criterion method (AIC Picker).

Further, a maximum amplitude value

$${A}_{max}^{p} ( x , t , s )$$

of the first arrival wave is searched at each spatial node, when each spatial node searches for

$${A}_{max}^{p} ( x , t , s ) ,$$

a calculation of the source wave field is terminated, reverse time continuation is performed on the receiver wave field using either the acoustic wave equation or the elastic wave equation, and the receiver wave field is calculated by the FDM, FEM, and PSM.

Further, the cross-correlating the maximum amplitude of the source wave field with the receiver wave field at the same moment on each spatial grid node according to an excitation time includes the steps of:
using an imaging condition

$$I ( x , s ) = {\sum }_{t = 0}^{{t}_{max}} {A}_{max}^{p} ( x , t , s ) {U}^{R} ( x , t , s ) \qquad ( 7 )$$

where I(x, s) represents an RTM result of an s^{th} shot; the receiver wave field is denoted as U^{R}(x, t, s), x represents a spatial location, t represents a time, s represents a shot number, and tₘₐₓ represents a maximum propagation time of the maximum amplitude of the first arrival wave;
superimposing migration results on all shot points to obtain RTM results on an entire profile:

$$I ( x ) = {\sum }_{s = 1}^{{S}_{max}} {\sum }_{t = 0}^{{t}_{max}} {A}_{max}^{p} ( x , t , s ) {U}^{R} ( x , t , s ) \qquad ( 8 )$$

where I(x) represents a superposition of all the RTM results of shots, and sₘₐₓ represents a maximum number of shots.

In another aspect, a first arrival wave RTM system based on excitation amplitude includes
a calculation module, configured to acquire calculation parameters of the seismic wave field, perform forward continuation on the source wave field, and perform reverse time continuation on the receiver wave field;
an identification module, configured to identify the first arrival wave of the source wave field, and preserve the maximum amplitude and corresponding time of the first arrival wave at each spatial grid node; and
an imaging module, configured to cross-correlate the maximum amplitude of the source wave field with the receiver wave field at the same moment on each spatial grid node according to the excitation time, and superimpose cross-correlation values at all moments to obtain the RTM result.

Compared with the related art, the present disclosure adopts the above technical solution and has the following greatest characteristics.

According to a method for performing RTM using first arrival wave excitation amplitude provided by the present disclosure, during the propagation of the source wave field, the maximum amplitude and time of the first arrival wave are preserved, and cross-correlation imaging is conducted with the receiver wave field. The present disclosure can reduce the calculation amount and the interference of multi-path waves and improve a signal-to-noise ratio while ensuring the RTM imaging capability.

### BRIEF DESCRIPTION OF THE DRAWINGS

FIG. 1 is a schematic flow diagram of a first arrival wave RTM of a first arrival wave RTM method and system based on excitation amplitude according to the present disclosure;

FIG. 2 is a schematic diagram of a three-layer horizontal layered medium model of the first arrival wave RTM method and system based on excitation amplitude according to the present disclosure;

FIG. 3a is a snapshot of a seismic wave field simulated by the three-layer model at a time of 0.75 s of the first arrival wave RTM method and system based on excitation amplitude;

FIG. 3b is a first arrival wave field diagram of the first arrival wave RTM method and system based on excitation amplitude;

FIG. 3c is a maximum amplitude diagram of the first arrival wave field of the first arrival wave RTM method and system based on excitation amplitude;

FIG. 4a is an RTM result diagram of the first arrival wave of the first arrival wave RTM method and system based on excitation amplitude according to the present disclosure;

FIG. 4b is an RTM result diagram of multi-path waves of the first arrival wave RTM method and system based on excitation amplitude according to the present disclosure;

FIG. 5 is a schematic diagram of a Sigsbee2a model of the first arrival wave RTM method and system based on excitation amplitude according to the present disclosure;

FIG. 6 is a 100^{th} shot seismic record diagram of a first arrival wave RTM method based on excitation amplitude according to the present disclosure;

FIG. 7 is a schematic diagram of a Sigsbee2a migration model of the first arrival wave RTM method based on excitation amplitude according to the present disclosure;

FIG. 8 is a schematic cross-sectional view of excitation amplitude RTM of an example of the first arrival wave RTM method based on excitation amplitude according to the present disclosure;

FIG. 9 is a schematic cross-sectional diagram of the first arrival wave excitation amplitude RTM of an example of the first arrival wave RTM method based on excitation amplitude according to the present disclosure;

FIG. 10 is a specific enlarged view of a white box 1 in a profile of the excitation amplitude RTM in FIG. 8 in an example of the first arrival wave RTM method based on excitation amplitude according to the present disclosure;

FIG. 11 is an enlarged view of a region shown in a white box 1 in a profile of the first arrival wave excitation amplitude RTM in FIG. 9 in an example of the first arrival wave RTM method based on excitation amplitude according to the present disclosure;

FIG. 12 is an enlarged view of reflection coefficients of the Sigsbee2a salt dome model in regions shown in boxes 1 in FIGS. 8 and 9 in an example of the first arrival wave RTM method based on excitation amplitude according to the present disclosure;

FIG. 13 is an enlarged view of a region shown in a white box 2 in FIG. 8 in a profile of the excitation amplitude RTM in an example of the first arrival wave RTM method based on excitation amplitude according to the present disclosure;

FIG. 14 is an enlarged view of a region shown in a white box 2 in FIG. 9 in a profile of the first arrival wave excitation amplitude RTM in an example of the first arrival wave RTM method based on excitation amplitude according to the present disclosure; and

FIG. 15 is an enlarged view of reflection coefficients of the Sigsbee2a salt dome model in regions shown in the boxes 2 in FIGS. 8 and 9 in an example of the first arrival wave RTM method based on excitation amplitude according to the present disclosure.

### DETAILED DESCRIPTION

Technical solutions in the examples of the present disclosure will be described clearly and completely in the following with reference to the attached drawings in the examples of the present disclosure. Obviously, all the described examples are only some, rather than all examples of the present disclosure. Based on the examples in the present disclosure, all other examples obtained by those ordinary skilled in the art without creative efforts belong to the protection scope of the present disclosure.

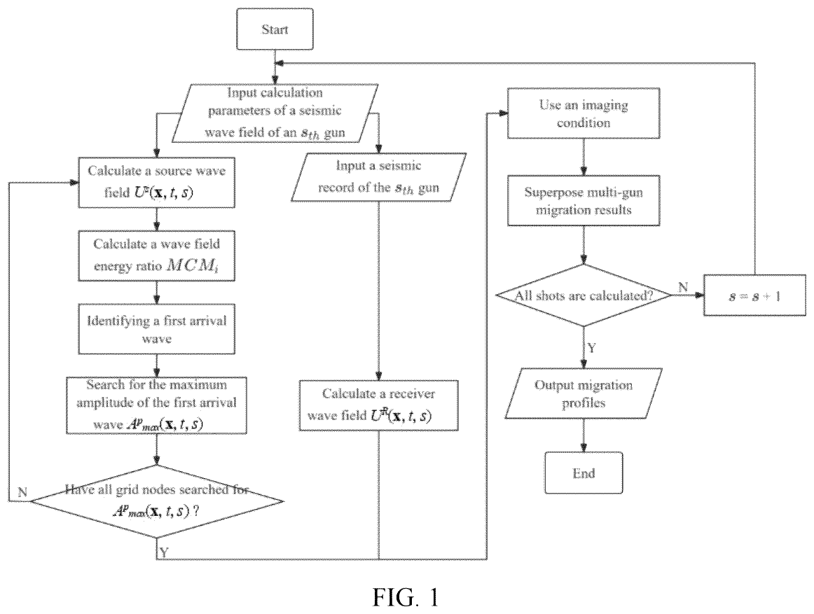

A flow chart is shown in FIG. 1, and the method includes the following steps.
(1) Forward continuation is performed on a source wave field, in which a first arrival wave of the forward continuation of the source wave field is identified, and the maximum amplitude and corresponding time of the first arrival wave are preserved at each spatial grid node.
(2) Reverse time continuation is performed on a receiver wave field.
(3) The maximum amplitude of the source wave field is cross-correlated with the receiver wave field at the same moment on each spatial grid node according to an excitation time, and cross-correlation values at all moments are superimposed to obtain an RTM result.

In this example, specific refinement steps are as follows.

In step 1, the given seismic wave field calculation parameters include grid size, number of grid nodes, seismic wave propagation velocity and density parameters at each grid node, spatial accuracy of numerical calculation of seismic wave field, time accuracy, and time step parameters.

In step 2, according to the parameters in step 1, the forward continuation of the source wave field is performed using an acoustic wave equation or an elastic wave equation, and the source wave field is calculated using numerical calculation methods including FDM, FEM, and PSM. The source wave field is denoted as U^{s}(x, t, s), where x represents a spatial location, t represents a time, and s represents a shot number.

In step 3, the first arrival wave of the source wave field is identified. There are many methods to identify the first arrival wave, including STA/LTA, MER, MCM and AIC. All these methods are to identify the first arrival wave of seismic records, and it is necessary to analyze wave field values at all recording times as a whole. These methods are applied to the RTM, a simple and direct method is to calculate and store the source wave field at all moments, and identify the first arrival wave, which undoubtedly requires a lot of calculation time and storage space. To save the calculation amount and improve the calculation efficiency, the present disclosure expects to identify the first arrival wave in a process of calculating the source wave field. Through the comparison of the existing methods, the present disclosure selects the MCM and improves the MCM to meet the requirement of calculation efficiency. The traditional MCM method is as follows:

$$EW {1}_{i} = {\sum }_{j = i - nl + 1}^{i} {w}_{j}^{2} \qquad ( 1 )$$

$$EW {2}_{i} = {\sum }_{j = 1}^{i} {w}_{j}^{2} \qquad ( 2 )$$

$${MCM}_{i} = \frac{EW {1}_{i}}{EW {2}_{i} + β} \qquad ( 3 )$$

when a molecule EW1ᵢ on MCMᵢ is calculated by Equation 1, it is necessary to calculate the addition nl times at each spatial node in each time step. To reduce the calculation amount, the present disclosure modifies equations (1) and (3) into the following forms:

$$EW {1}_{i} = {\sum }_{j = 1}^{i - nl} {w}_{j}^{2} \qquad ( 4 )$$

$${MCM}_{i} = \frac{EW {2}_{i} - EW {1}_{i}}{EW {2}_{i} + β} \qquad ( 5 )$$

where i and j are the number of time steps; nl is a selected time window, corresponding to 2-3 dominant periods of the seismic wavelet; w is a seismic wave field value, and EW1ᵢ is a sum of all energy values of the seismic wave field from i−nl+1^{th} to i^{th} time steps; EW2ᵢ is a sum of all energy values of the seismic wave field from the 1^{st} to i^{th} time steps; MCMᵢ is a ratio of EW1ᵢ to EW2ᵢ; and β is a stabilization factor to prevent the denominator from having a value of 0, generally taking a value of 0.2. At this time, the numerator on MCMᵢ only needs to calculate one addition and one subtraction at each spatial node at each time step, which greatly reduces the calculation amount.

Fᵢ is set as a first arrival wave identification factor, with an expression of:

$${F}_{i} = \{ \begin{matrix}1 & {MCM}_{i} >= th \\ 0 & {MCM}_{i} < th\end{matrix} \qquad ( 6 )$$

where th is a given threshold, and when a value F corresponding to a wave field value at a certain moment step equals 1, it indicates that the wave field is the first arrival wave.

In step 4, a maximum amplitude value

$${A}_{max}^{p} ( x , t , s )$$

of the first arrival wave is searched at each spatial node and stored in the memory, when each spatial node searches for

$${A}_{max}^{p} ( x , t , s ) ,$$

a calculation of the source wave field is terminated.

In step 5, according to the parameters in step 1, reverse time continuation is performed on the receiver wave field using either the acoustic wave equation or the elastic wave equation, and the receiver wave field is calculated by the FDM, FEM, and PSM, where the receiver wave field is recorded as U^{R}(x, t, s).

In step 6, an imaging condition formula is used as:

$$I ( x , s ) = {\sum }_{t = 0}^{{t}_{max}} {A}_{max}^{p} ( x , t , s ) {U}^{R} ( x , t , s ) \qquad ( 7 )$$

where x represents a spatial location, t represents a time, and s represents a shot number. I(x, s) represents an RTM result of an s^{th} shot.

In step 7, migration results on all shot points are superimposed to obtain RTM results on an entire profile:

$$I ( x ) = {\sum }_{s = 1}^{{S}_{max}} {\sum }_{t = 0}^{{t}_{max}} {A}_{max}^{p} ( x , t , s ) {U}^{R} ( x , t , s ) \qquad ( 8 )$$

where I(x) represents a superposition of all the RTM results of shots.

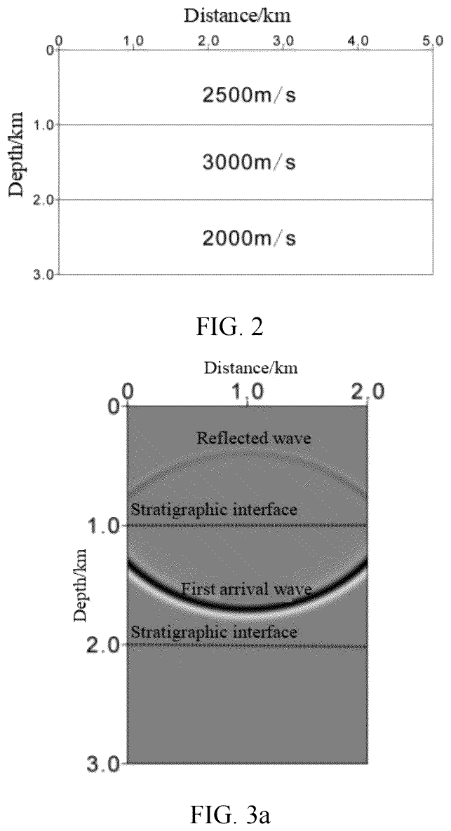

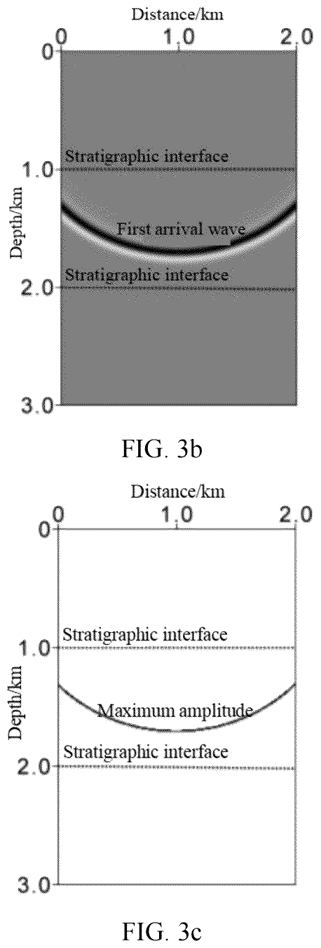

In this example, a three-layer geological model is adopted. FIG. 2 shows a three-layer horizontal layered geological model, and depths of two stratigraphic interfaces are 1 km and 2 km underground. The acoustic wave equation is used to simulate the seismic wave field, as shown in FIG. 3a. The numerical calculation method adopts the FDM, and the source is an explosion source, which is placed at a horizontal distance of 1 km from the surface. The seismic wavelet is a Rake wavelet, a dominant frequency is 20 Hz, a spatial step is 10 m, and a time step is 1 ms.

FIG. 3a is a snapshot of the seismic wave field at 0.75 s. FIG. 3b is the first arrival wave field identified by the method of the present disclosure, when calculating MCMᵢ, nl is selected as two dominant periods of seismic wavelet, that is, 100 ms, and a threshold value is set to 0.9 when calculating the first arrival wave identification factor Fᵢ. FIG. 3c is the maximum amplitude of the first arrival wave field, that is, the excitation amplitude.

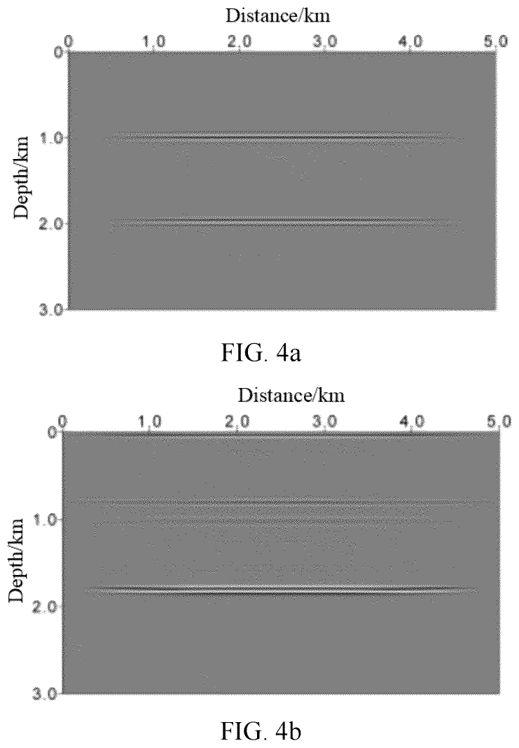

FIG. 4a is a first arrival wave RTM image calculated by the method of the present disclosure. A total number of shots is 60, positions of shots are from 1 km to 4 km, and a distance between shots is 50 m. It can be seen from FIG. 4a that geological interfaces at 1 km and 2 km underground are accurately imaged. FIG. 4b is an RTM image of multi-path waves. A method of multi-path wave RTM is to identify the first arrival wave during a propagation of the source wave field, and the subsequent seismic wave field is regarded as the multi-path waves. Five maximum amplitudes of multi-path waves and corresponding times thereof are identified, and are cross-correlated with the receiver wave field. It can be seen that although there is an obvious horizontal interface, its depth is inaccurate. It shows that the migration result obtained by cross-correlation of multi-path waves directly with the receiver wave field is migration noise, and an accurate image of underground medium cannot be obtained.

### Complex Model Application Effect

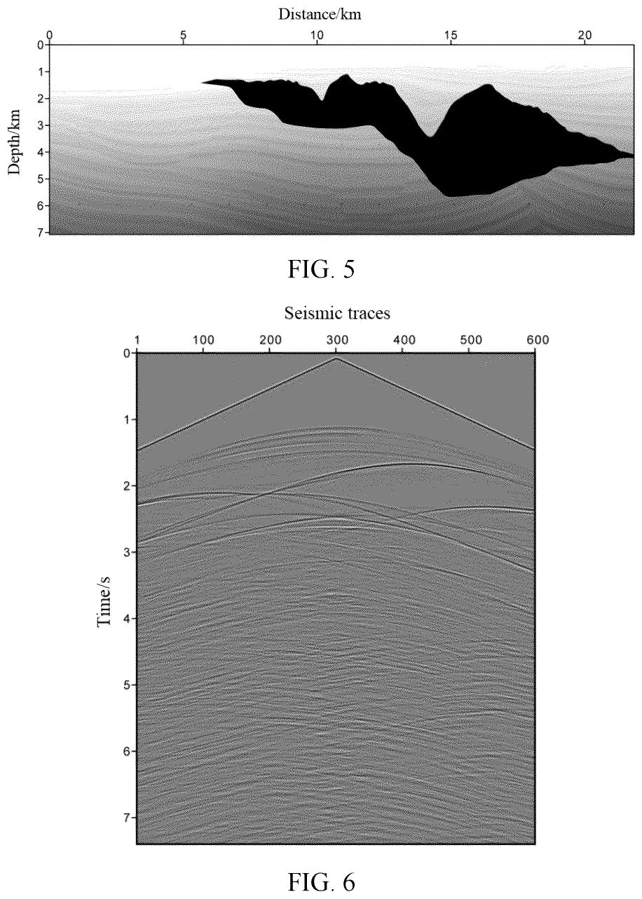

FIG. 5 is a seismic wave velocity distribution diagram of a Sigsbee2a salt dome model. In forward modeling of seismic records, the source is an explosion source and placed on the surface, with a horizontal position of 0.7 km-21 km and a shot distance of 98 m, totaling 215 shots. The seismic wavelet is selected as the Ricker wavelet, and the dominant frequency is 20 Hz. The numerical calculation method adopts the FDM with a spatial step of 7 m, a time step of 0.8 ms, and a recording time of 7.4 s. The simulated seismic records are shown in FIG. 6.

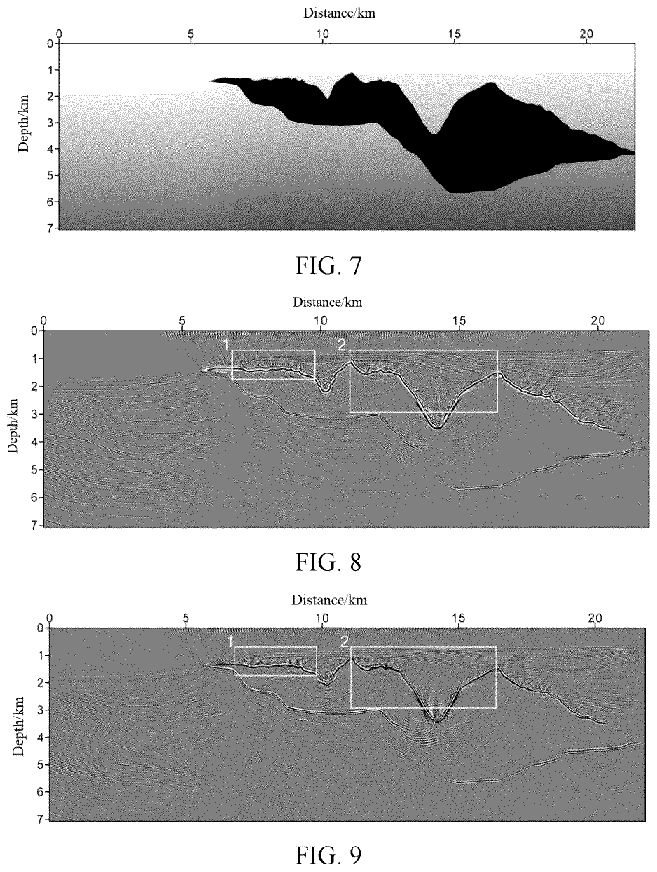

The parameters of RTM are the same as those of forward modeling, and the migration speed used is shown in FIG. 7. FIGS. 8 and 9 are excitation amplitude RTM profiles and RTM profiles obtained by the method of the present disclosure. Comparing FIGS. 8 and 9, it can be seen that the noise in FIG. 8 is stronger than that in FIG. 9.

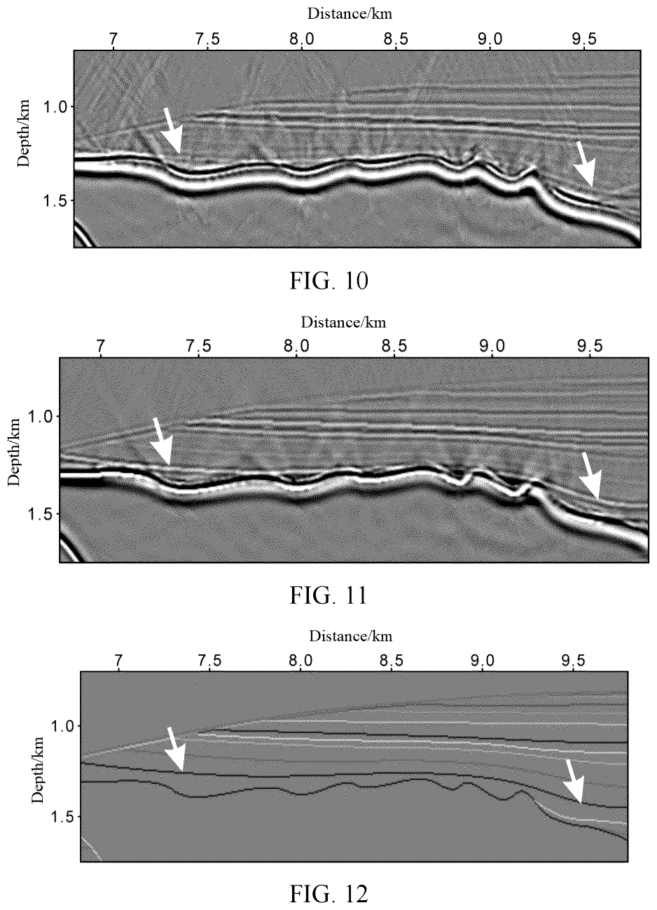

FIGS. 10 and 11 are enlarged views of regions shown in white boxes 1 in FIGS. 8 and 9. FIG. 12 is an enlarged view of reflection coefficients of the Sigsbee2a salt dome model in corresponding regions, which can clearly indicate locations of geological interfaces. The geological interfaces shown by white arrows can be seen, and are successfully imaged by the method of the present disclosure but not effectively imaged by the excitation amplitude method. At the same time, after testing, a signal-to-noise ratio of the method of the present disclosure is obviously higher than that of the excitation amplitude imaging method.

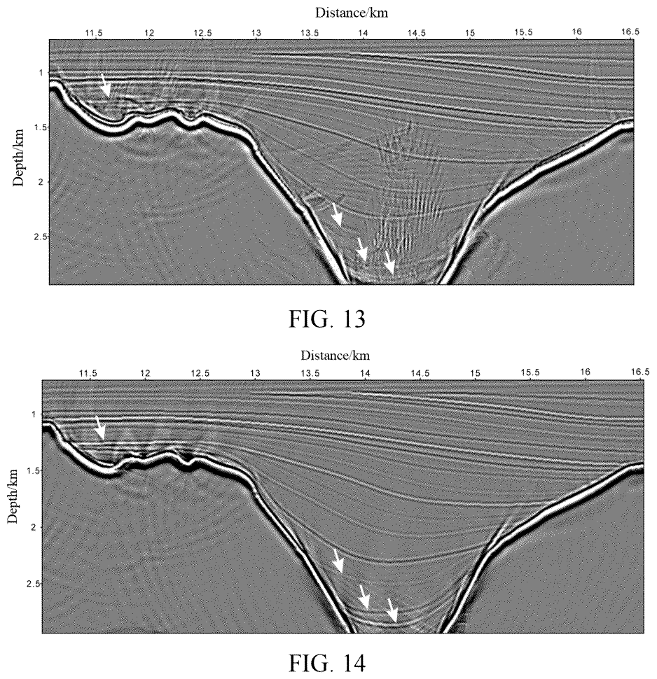

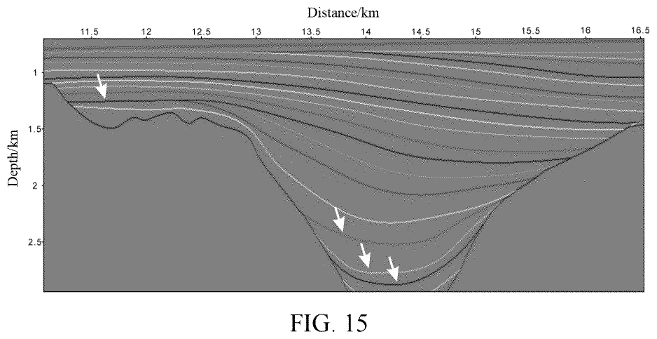

FIGS. 13 and 14 are enlarged views of regions shown in white boxes 2 in FIGS. 8 and 9. FIG. 15 is an enlarged view of the reflection coefficients of the Sigsbee2a salt dome model in the corresponding regions. Similarly, formations shown by white arrows are successfully imaged by the method of the present disclosure but not effectively imaged by the excitation amplitude method, and the signal-to-noise ratio of the method of the present disclosure is significantly higher than that of the excitation amplitude imaging method.

The RTM profiles obtained by the method of the present disclosure have higher signal-to-noise ratio and stronger imaging capability. In the example, the present disclosure successfully images the geological interfaces that the excitation amplitude method fails to image. At the same time, the present disclosure only needs the amplitude of the first arrival wave in the source wave field, and does not need to calculate the source wave field at all moments, while the excitation amplitude method needs to search the source wave field at all moments to obtain the maximum amplitude. For instance, the seismic record of Sigsbee2a in the example is 7.4 s. To obtain the maximum amplitude at all grid points within the calculation region of each shot by the excitation amplitude method, the source wave field of 7.4 s needs to be calculated. However, the method of the present disclosure only needs about 4 s to terminate the calculation of the source wave field, and the calculation amount of the present disclosure is smaller and the efficiency is higher.

The above contents are merely instances and illustrations of the structure of the present disclosure. Those skilled in the art make various modifications, supplements or substitutes in a similar way to the specific examples described herein. As long as these changes do not deviate from the structure of the present disclosure or exceed the scope defined by the claims, they shall fall within the protection scope of the present disclosure.

1. A first arrival wave reverse time migration (RTM) method based on excitation amplitude, specifically comprising the steps of:
acquiring calculation parameters of a seismic wave field, performing forward continuation on a source wave field, identifying a first arrival wave of the source wave field, and preserving the maximum amplitude and corresponding time of the first arrival wave at each spatial grid node;
performing reverse time continuation on a receiver wave field; and
cross-correlating the maximum amplitude of the source wave field with the receiver wave field at the same moment on each spatial grid node according to an excitation time, and superimposing cross-correlation values at all moments to obtain an RTM result;
the identifying a first arrival wave of the source wave field comprising the following calculation formulas:
$$EW {2}_{i} = {\sum }_{j = 1}^{i} {w}_{j}^{2} \qquad ( 2 )$$
$$EW {1}_{i} = {\sum }_{j = 1}^{i - nl} {w}_{j}^{2} \qquad ( 4 )$$
$${MCM}_{i} = \frac{EW {2}_{i} - EW {1}_{i}}{EW {2}_{i} + β} \qquad ( 5 )$$
setting Fᵢ as a first arrival wave identification factor, with an expression of:
$${F}_{i} = \{ \begin{matrix}1 & {MCM}_{i} >= th \\ 0 & {MCM}_{i} < th\end{matrix} \qquad ( 6 )$$
where i and j are the number of time steps; nl is a selected time window, corresponding to 2-3 dominant periods of a seismic wavelet; w is a seismic wave field value,
$${w}_{j}^{2}$$
represents a square of the seismic wave field value at an j^{th} time step, and EW1ᵢ is a sum of energy values of the seismic wave field from 1^{st} to i−nl^{th} time steps; EW2ᵢ is a sum of energy values of the seismic wave field from 1^{st} to i^{th} time steps; MCMᵢ is a ratio of a sum of energy values of the seismic wave field from i−nl+1^{th} to i^{th} time steps to EW2ᵢ; and β is a stabilization factor with a value of 0.2, th is a given threshold, and when a value F corresponding to a wave field value at a certain moment equals 1, it indicates that the wave field is the first arrival wave.

2. The first arrival wave RTM method based on excitation amplitude according to claim 1, wherein the acquiring calculation parameters of a seismic wave field comprises: acquiring grid size, number of grid nodes, seismic wave propagation velocity and density parameters at each grid node, spatial accuracy of numerical calculation of seismic wave field, time accuracy, and time step parameters; forward continuation is performed on the source wave field using an acoustic wave equation or an elastic wave equation, and the source wave field is calculated using numerical calculation methods comprising finite-difference method (FDM), finite-element method (FEM), and pseudo-spectral method (PSM); and the source wave field is denoted as U^{s}(x, t, s), where x represents a spatial location, t represents a time, and s represents a shot number.

3. The first arrival wave RTM method based on excitation amplitude according to claim 1, wherein the identifying a first arrival wave adopts a short-time average/long-time average ratio method (STA/LTA method), a modified energy ratio method (modified method), a modified Coppen method, or an Akaike information criterion method (AIC Picker).

4. The first arrival wave RTM method based on excitation amplitude according to claim 1, wherein a maximum amplitude value
$${A}_{max}^{p} ( x , t , s )$$
of the first arrival wave is searched at each spatial node, when each spatial node searches for
$${A}_{max}^{p} ( x , t , s ) ,$$
a calculation of the source wave field is terminated, reverse time continuation is performed on the receiver wave field using either the acoustic wave equation or the elastic wave equation, and the receiver wave field is calculated by the FDM, FEM, and PSM.

5. The first arrival wave RTM method based on excitation amplitude according to claim 1, wherein the cross-correlating the maximum amplitude of the source wave field with the receiver wave field at the same moment on each spatial grid node according to an excitation time comprises the steps of: using an imaging condition
$$I ( x , s ) = {\sum }_{t = 0}^{{t}_{max}} {A}_{max}^{p} ( x , t , s ) {U}^{R} ( x , t , s ) \qquad ( 7 )$$
where I(x, s) represents an RTM result of an s^{th} shot, the receiver wave field is denoted as U^{R}(x, t, s), x represents a spatial location, t represents a time, s represents a shot number, and tₘₐₓ represents a maximum propagation time of the maximum amplitude of the first arrival wave;
superimposing migration results on all shot points to obtain RTM results on an entire profile:
$$I ( x ) = {\sum }_{s = 1}^{{S}_{max}} {\sum }_{t = 0}^{{t}_{max}} {A}_{max}^{p} ( x , t , s ) {U}^{R} ( x , t , s ) \qquad ( 8 )$$
where I(x) represents a superposition of all the RTM results of shots, and sₘₐₓ represents a maximum number of shots.

6. A first arrival wave RTM system based on excitation amplitude, for implementing the first-arrival wave RTM method based on excitation amplitude according to claim 1, comprising
a calculation module, configured to acquire calculation parameters of the seismic wave field, perform forward continuation on the source wave field, and perform reverse time continuation on the receiver wave field;
an identification module, configured to identify the first arrival wave of the source wave field, and preserve the maximum amplitude and corresponding time of the first arrival wave at each spatial grid node; and
an imaging module, configured to cross-correlate the maximum amplitude of the source wave field with the receiver wave field at the same moment on each spatial grid node according to the excitation time, and superimpose cross-correlation values at all moments to obtain the RTM result.

7. A first arrival wave RTM system based on excitation amplitude, for implementing the first-arrival wave RTM method based on excitation amplitude according to claim 2, comprising
a calculation module, configured to acquire calculation parameters of the seismic wave field, perform forward continuation on the source wave field, and perform reverse time continuation on the receiver wave field;
an identification module, configured to identify the first arrival wave of the source wave field, and preserve the maximum amplitude and corresponding time of the first arrival wave at each spatial grid node; and
an imaging module, configured to cross-correlate the maximum amplitude of the source wave field with the receiver wave field at the same moment on each spatial grid node according to the excitation time, and superimpose cross-correlation values at all moments to obtain the RTM result.

8. A first arrival wave RTM system based on excitation amplitude, for implementing the first-arrival wave RTM method based on excitation amplitude according to claim 3, comprising
a calculation module, configured to acquire calculation parameters of the seismic wave field, perform forward continuation on the source wave field, and perform reverse time continuation on the receiver wave field;
an identification module, configured to identify the first arrival wave of the source wave field, and preserve the maximum amplitude and corresponding time of the first arrival wave at each spatial grid node; and
an imaging module, configured to cross-correlate the maximum amplitude of the source wave field with the receiver wave field at the same moment on each spatial grid node according to the excitation time, and superimpose cross-correlation values at all moments to obtain the RTM result.

9. A first arrival wave RTM system based on excitation amplitude, for implementing the first-arrival wave RTM method based on excitation amplitude according to claim 4, comprising
a calculation module, configured to acquire calculation parameters of the seismic wave field, perform forward continuation on the source wave field, and perform reverse time continuation on the receiver wave field;
an identification module, configured to identify the first arrival wave of the source wave field, and preserve the maximum amplitude and corresponding time of the first arrival wave at each spatial grid node; and
an imaging module, configured to cross-correlate the maximum amplitude of the source wave field with the receiver wave field at the same moment on each spatial grid node according to the excitation time, and superimpose cross-correlation values at all moments to obtain the RTM result.

10. A first arrival wave RTM system based on excitation amplitude, for implementing the first-arrival wave RTM method based on excitation amplitude according to claim 5, comprising
a calculation module, configured to acquire calculation parameters of the seismic wave field, perform forward continuation on the source wave field, and perform reverse time continuation on the receiver wave field;
an identification module, configured to identify the first arrival wave of the source wave field, and preserve the maximum amplitude and corresponding time of the first arrival wave at each spatial grid node; and
an imaging module, configured to cross-correlate the maximum amplitude of the source wave field with the receiver wave field at the same moment on each spatial grid node according to the excitation time, and superimpose cross-correlation values at all moments to obtain the RTM result.
